(19) United States
(12) Patent Application Publication
(10) Pub. No.: US 2017/0287025 A1
(43) Pub. Date: Oct. 5, 2017

(54) PRODUCT INFORMATION MANAGEMENT DEVICE

(71) Applicant: RAINUS CO.,LTD., Suwon-si, Gyeonggi-do (KR)

(72) Inventor: Hyun-Hak KIM, Osan-si (KR)

(73) Assignee: RAINUS CO.,LTD., Suwon-si, Gyeonggi-do (KR)

(21) Appl. No.: 15/514,513

(22) PCT Filed: Aug. 31, 2015
(86) PCT No.: PCT/KR2015/009117

§ 371 Date: Mar. 25, 2017

(30) Foreign Application Priority Data
Sep. 25, 2014 (KR) 10-2014-0128362

(51) Int. Cl. G06Q 30/06; G06K 19/07

(52) U.S. Cl. CPC G06Q 30/0601; G06K 19/0723

(57) ABSTRACT

The present invention relates to a product information management device. The product information management device, according to one embodiment of the present invention, comprises: a legacy interface unit for receiving, from a web server, product information to be displayed on electronic labels corresponding to respective products to be displayed on shelves; an information management unit for generating layout information for arranging the product information on the electronic labels, and image information to be displayed on the electronic labels together with the product information; and a communication unit for transmitting, to the electronic labels, the product information, the layout information, and the image information through a gateway module by multiple frequency channels, and updating the product information through a wake up command when the electronic labels are in a sleep mode. According to the present invention, product information to be displayed on electronic labels is managed and updated by using a web server such that the electronic labels and the product information can easily be managed in real time at any location.

### TECHNICAL FIELD

The present invention relates to a product information management device.

### BACKGROUND ART

In stores where many products are sold, such as large retail stores, labels having product information, such as names, prices, barcodes, or the like of products, recorded thereon are attached to the products so as to allow consumers to easily recognize information on the products displayed on the racks.

In large scale distribution networks such as large retail stores, products are rapidly distributed and displayed products are replaced on a basis of a few days or a few weeks. In this case, labels recorded on paper should be discarded, but this may cause a great loss in resources for re-creating labels and cause waste of manpower. In recent years, electronic labels having product information electronically recorded thereon and displaying the product information are used, and the information recorded on the electronic labels can be easily changed by a simple operation.

FIG. 1 is a view to illustrate a method for managing electronic labels and product information by using a related-art management server. Referring to FIG. 1, a management server 104 receives product information on various products displayed on store shelves from a legacy system 102, and stores the received product information in a database 106. The product information stored in this way is transmitted to respective electronic labels 12, 14, 16, . . . through a gateway module 108, and the electronic labels 12, 14, 16, . . . display the transmitted product information on a panel according to a predetermined format. A manager of a store may request the management server 104 to update product information to be displayed on the electronic labels 12, 14, 16, . . . through a management terminal 110.

However, according to the method for managing electronic labels and product information by using the related-art management server, the management server 104 should receive the product information only through the legacy system 102. Therefore, there is a disadvantage that product information can be managed only in a limited area. In addition, a single communication module is mounted in the related-art gateway module 108. However, since communication is performed via a single frequency channel by the single communication module, there is a limit to managing a plurality of electronic labels in a large store.

### DISCLOSURE OF INVENTION

### Technical Problem

An object of the present invention is to provide a product information management device which manages and updates product information to be displayed on electronic labels by using a web server, such that the electronic labels and the product information can be easily managed in real time at any location.

Objects of the present invention are not limited to the above-mentioned object, and other objects and advantages of the present invention which are not mentioned herein could be understood by the following description and could be clearly understood by embodiments of the present invention. In addition, it could be seen that the objects and advantages of the present invention can be achieved by means described in the claims and a combination thereof.

### Technical Solution

To achieve the above-described objects, the present invention provides a product information management device, including: a legacy interface unit for receiving, from a web server, product information to be displayed on electronic labels corresponding to respective products to be displayed on shelves; an information management unit for generating layout information for arranging the product information on the electronic labels, and image information to be displayed on the electronic labels together with the product information; and a communication unit for transmitting, to the electronic labels, the product information, the layout information, and the image information through a gateway module by multiple frequency channels, and updating the product information through a wake up command when the electronic labels are in a sleep mode.

### Advantageous Effects

According to the present invention as described above, product information to be displayed on electronic labels is managed and updated by using a web server, such that the electronic labels and the product information can easily be managed in real time at any location.

### BRIEF DESCRIPTION OF DRAWINGS

FIG. 1 is a view to illustrate a method for managing electronic labels and product information by using a related-art management server;

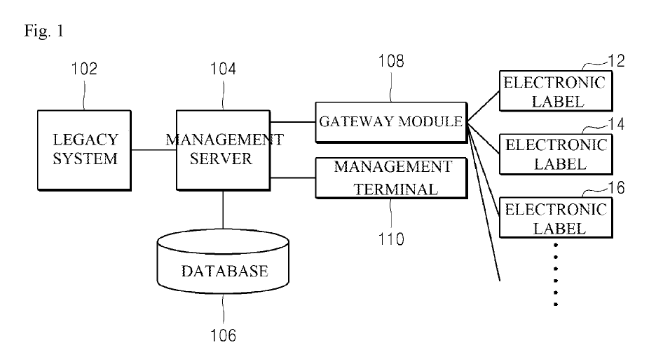

FIG. 2 is a configuration diagram showing a configuration of a product information management device according to the present invention; and

FIG. 3 is a flowchart showing a process of updating product information by using the product information management device according to the present invention.

### BEST MODE FOR EMBODYING THE INVENTION

The above-described objects, features, and advantages will be described in detail with reference to the accompanying drawings, and accordingly, a person skilled in the art to which the present invention belongs can easily implement technical idea of the present invention. In the description of the present invention, certain detailed explanations of related art are omitted when it is deemed that they may unnecessarily obscure the essence of the present invention. Hereinafter, preferred embodiments of the present invention will be described in detail with reference to the accompanying drawings. In the drawings, same reference numerals are used for the same or similar elements.

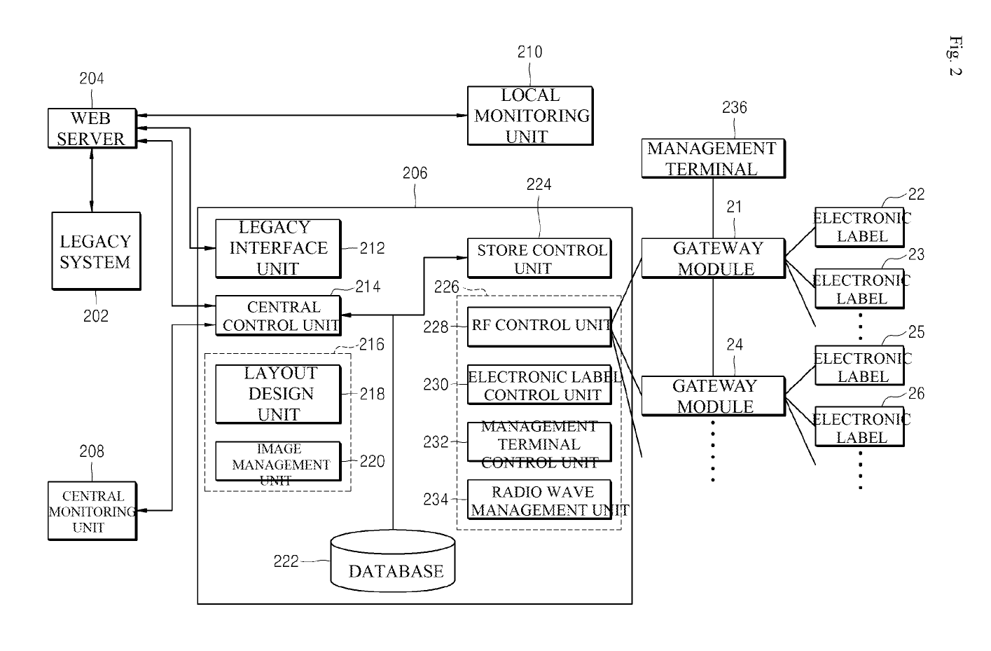

FIG. 2 is a configuration diagram showing a configuration of a product information management device according to the present invention.

Referring to FIG. 2, the product information management device 206 according to the present invention includes a legacy interface unit 212, a central control unit 214, an information management unit 216, a database 222, a store control unit 224, and a communication unit 226. In addition, the information management unit 216 includes a layout design unit 218 and an image management unit 220, and the communication unit 226 includes an RF control unit 228, an electronic label control unit 20, a management terminal control unit 232, and a radio wave management unit 234.

The legacy interface unit 212 receives, from a web server 204, product information to be displayed on electronic labels 22, 23, 25, 26, . . . corresponding to respective products displayed on shelves. The web server 204 may receive the product information on the respective products from a legacy system 202 in real time. The legacy system 202 stores the product information on the respective products, and product information may be newly generated or product information stored in the legacy system 202 may be modified by a manager. When product information is newly generated or production information is modified, the legacy system 202 may transmit the newly generated product information or the modified product information to the web server 204 in real time. The newly generated product information or modified product information may be notified to the central control unit 214 through the web server 204, and the central control unit 214 may control the legacy interface unit 212 to receive the new product information or the modified product information from the web server 204 in real time. The product information received through the legacy interface unit 212 as described above may be stored in the database 222 in real time.

The product information according to the present invention may include name information, price information, and barcode information of the respective products.

The information management unit 216 serves to generate layout information for arranging the product information received through the legacy interface unit 212 on the electronic labels 22, 23, 25, 26, . . . , and image information to be displayed on the electronic labels 22, 23, 25, 26, . . . along with the product information.

More specifically, the layout design unit 218 analyzes the product information received through the legacy interface unit 212, generates images and texts of the respective products to be displayed on the electronic labels 22, 23, 25, 26, . . . , and generates area information of the images and the texts to be displayed on the panels of the electronic labels 22, 23, 25, 26, . . . , and layout information including the generated images and texts.

In addition, the image management unit 220 generates image information including size information and location information of the images generated by the layout design unit 218 so as to make the images fit the panel sizes of the electronic labels 22, 23, 25, 26 . . . .

The central control unit 214 may store the layout information and the image information generated by the information management unit 216 in the data base 222 along with the product information received through the legacy interface unit 212, or may deliver the layout information and the image information to the store control unit 224 along with the product information.

The store control unit 224 controls the communication unit 226 to transmit the product information, the layout information, and the image information to the electronic labels 22, 23, 25, 26, . . . via gateway modules 21, 24, . . . . The communication unit 226 may exchange data with the electronic labels 22, 23, 25, 26, . . . by communicating with the gateway modules 21, 24, . . . via wired or wireless communication.

The RF control unit 228 allocates and manages frequency channels of the gateway modules 21, 24, . . . in order to transmit massive data. The gateway modules 21, 24, . . . of the present invention communicate with the electronic labels 22, 23, 25, 26, . . . by using multiple frequency channels. Accordingly, each of the gateway modules 21, 24, . . . may include a plurality of communication modules so as to be able to perform multiple frequency channel communication.

In the present invention, individual frequency channels forming the multiple frequency channels include a data channel for transmitting and receiving data (product information, layout information, image information, or the like) between the gateway modules 21, 24, . . . and the electronic labels 22, 23, 25, 26, . . . , and a wake up channel for transmitting a wake up command. Accordingly, the RF control unit 228 serves to allocate the data channel and the wake up channel to each gateway module, and manage the data channel and the wake up channel.

As a result, each of the gateway modules 21, 24, . . . according to the present invention includes the plurality of communication modules, and performs multiple frequency channel communication via the plurality of communication modules, thereby rapidly delivering massive data to the plurality of electronic labels.

In addition, the RF control unit 228 may allocate a plurality of channels to each of the gateway modules by using a space-time division scheduling (STDS) algorithm. For example, the RF control unit 228 may allocate a frequency channel of each time-space to each gateway in chronological order by considering space information, such as a pre-divided plurality of store areas or an area managed by each gateway module, and the locations and the number of electronic labels managed by each gateway module. By being allocated the frequency channels of each time-space, the gateway modules 21, 24, . . . may transmit data and a wake up signal to the electronic labels without interfering with one another. Accordingly, the electronic labels 22, 23, 25, 26, . . . may transmit and receive data via the multiple frequency channels according to predetermined chronological order.

The electronic label control unit 230 may receive information on a radio wave environment (frequency information, a signal intensity, a noise, an interference level, or the like) of an area where the electronic labels 22, 23, 25, 26, . . . are installed, which is measured by the electronic labels 22, 23, 25, 26, . . . and state information of the electronic labels 22, 23, 25, 26, . . . (communication state information, connection state information with the gateway, normality/abnormality information, remaining battery level information, or the like), and may transmit the information to the store control unit 224 in real time. The store control unit 224 provides the radio wave environment information and the state information to a central monitoring unit 208, a local monitoring unit 210, or a management terminal 236, such that the electronic labels 22, 23, 25, 26, . . . can be easily managed.

The management terminal control unit 232 may receive radio wave environment information (frequency information, a signal intensity, a noise, an interference level, or the like) of the surroundings of the management terminal 236, and state information (communication state information, connection state information with the gateway, normality/abnormality information, remaining battery level information) in real time, and may deliver the information to the store control unit 224 in real time. The store control unit 224 may provide the radio wave environment information or the state information to the central monitoring unit 208 or the local monitoring unit 210. In addition, the management terminal control unit 232 may allocate and manage an IP address, a communication channel, or the like of each management terminal 236.

The radio wave management unit 234 manages information related to radio waves which are used by the product information management device 206, and manages a frequency between devices and checks radio waves.

A manager may access the web server 204 via the central control unit 214 by using the central monitoring unit 208 or may directly access the web server 204 without passing through the central control unit 214, to generate or modify the product information. In addition, the manager may access the web server 204 via the local monitoring unit 210 to generate or modify the product information. When the central monitoring unit 208 or the local monitoring unit 210 accesses the web server 204, the access is allowed only when the central monitoring unit 208 or the local monitoring unit 210 passes an authentication process by means of a predetermined ID/password or other authenticating means. In one embodiment of the present invention, the central monitoring unit 208 may be installed in a main office managing many stores, and the local monitoring unit 210 may be installed in each store. Accordingly, the central monitoring unit 208 may perform the function of generating and modifying the product information for the product information management device 206 installed in all stores, and the local monitoring unit 210 may perform the function of generating and modifying the product information only for the products displayed in each store.

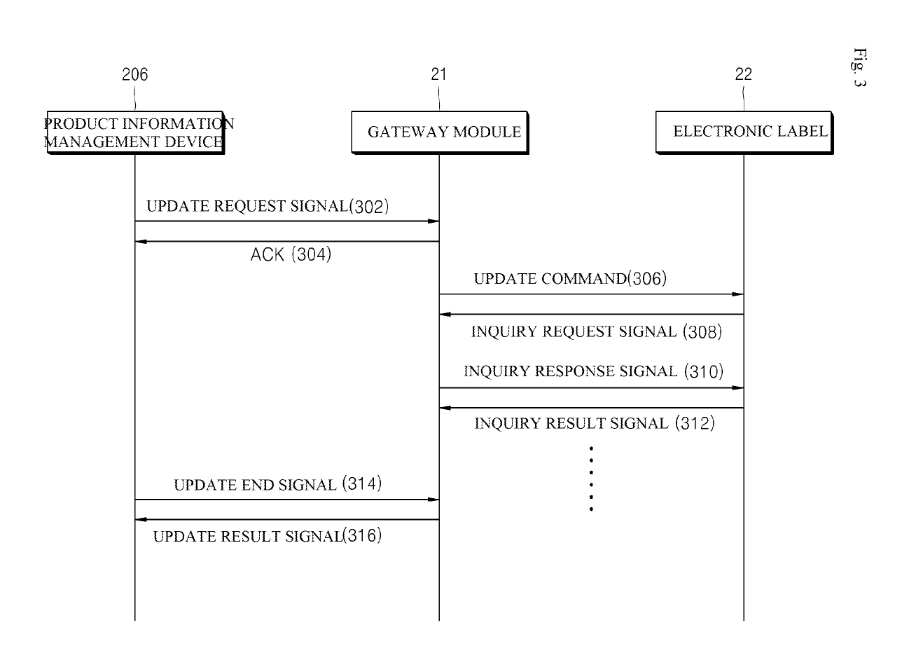

FIG. 3 is a flowchart showing a process of updating product information by the product information management device according to the present invention.

In one embodiment of the present invention, an electronic label is provided with a panel for displaying product information. The panel may include an LCD, a PDP, an electronic ink panel, or the like. The product information displayed on the electronic label is not changed during a predetermined time and is kept being displayed. Therefore, the electronic label which receives and displays the product information enters a sleep mode where it does not perform communication any more after the predetermined time elapses.

In this case, when there is a change in the product corresponding to the electronic label or in the product information, the product information is required to be updated. For example, when a request for updating of the product information is generated through the web server 204 by the central monitoring unit 208 or the local monitoring unit 210, the product information management device 206 transmits an update request signal 302 to the gateway module 21 as shown in FIG. 3. The gateway module 21 which receives the update request signal 302 transmits an ACK signal 304 to the product information management device 206. When an error occurs in the gateway module 21 or the electronic label 22, corresponding error details may be included in the ACK signal 304.

The update request signal 302 transmitted by the product information management device 206 includes update information. The update information includes product information to be updated, layout information, image information, or the like. The gateway module 21 acquires the product information to be updated, the layout information, and the image information by parsing the update information, and then transmits a wake up command 306 to the electronic label 22 which is in the sleep mode via the wake up channel. The electronic label 22 cancels the sleep mode after receiving the wake up command 306, and enters a state in which it can perform data communication via the data channel.

Thereafter, the electronic label 22 transmits an inquiry request signal 308 to the gateway module 21 via the data channel. Accordingly, the gateway module 21 transmits an inquiry response signal 310 to the electronic label 22 via the data channel.

The inquiry response signal 310 includes the product information, the layout information, and the image information which are acquired by parsing the update request signal 302 as described above. After receiving the inquiry response signal 310, the electronic label 22 updates the product information displayed on the panel by using the product information, the layout information, and the image information, which are included in the inquiry response signal 310. When the updating of the product information is completed, the electronic label 22 transmits an inquiry result signal 312 to the gateway module 21. The inquiry result signal 312 may include information on whether the updating succeeds or an error occurs and error details.

The gateway module 21 which receives the inquiry result signal 312 receives an update end signal 314 from the product information management device 206. The update end signal 314 may include an “END” flag to instruct the end of the updating. After receiving the update end signal 314, the gateway module 21 transmits an update result signal 316 to the product information management device 206. The update result signal 316 may include information on whether the product information of the electronic label 22 is successfully updated or an error occurs, and error details.

The present invention as described above has the following advantages:

1)When the system is extended by developing an electronic label system of a web method, a cost for installing and managing equipment can be minimized, and an installation and maintenance cost saving effect can be achieved.
An extra license cost is not required.
Since information is received via a web server, it is very easy to configure a system interface.
Since a capacity is small in comparison to a related-art electronic label system as in cited inventions, a cost for installing can be reduced.

2) It is possible to manage electronic labels at any time at any location by accessing through a computer.

3)It is possible to access a system in a mobile environment such as a personal smart phone and thus it is easy to manage.

Various substitutions, modifications, and changes can be made to the present invention by a person skilled in the art without departing from the technical idea of the present invention, and thus the present invention is not limited by the above-described embodiments and the accompanying drawings.

What is claimed is:

1. A product information management device comprising:
a legacy interface unit for receiving, from a web server, product information to be displayed on electronic labels corresponding to respective products to be displayed on shelves;
an information management unit for generating layout information for arranging the product information on the electronic labels, and image information to be displayed on the electronic labels together with the product information; and
a communication unit for transmitting, to the electronic labels, the product information, the layout information, and the image information through a gateway module by multiple frequency channels, and updating the product information through a wake up command when the electronic labels are in a sleep mode.

2. The product information management device of claim 1, wherein the web server receives the product information from a legacy system, and wherein, when new product information is generated or the product information is modified, the legacy system transmits the new product information or the modified product information to the web server.

3. The product information management device of claim 1, wherein the communication unit allocates and manages a data channel for transmitting and receiving data between the gateway module and the electronic label, and a wake up channel for transmitting the wake up command.

4. The product information management device of claim 1, wherein the gateway module comprises a plurality of communication modules for communicating with the plurality of electronic labels through multiple frequency channels.

5. The product information management device of claim 1, wherein the gateway module allocates a plurality of channels by using a space-time division scheduling (STDS) algorithm, and communicates with the plurality of electronic labels.

6. The product information management device of claim 1, wherein the gateway module transmits the wake up command to the electronic labels in the sleep mode through an update channel, and, when a request for transmission of update information is transmitted from the electronic labels which are released from the sleep mode by the wake up command through the data channel, the gateway module transmits the update information to the electronic labels through the data channel.
